(19) United States
(12) Patent Application Publication
(10) Pub. No.: US 2014/0029317 A1
(43) Pub. Date: Jan. 30, 2014

(54) Non-Contact Transformer

(71) Applicant: PHIHONG TECHNOLOGY CO.,LTD., Taoyuan County (TW)

(72) Inventors: Chun-Chen CHEN, Taoyuan County (TW); Po-Ching YU, Taoyuan County (TW); Wei-Chun CHANG, Taoyuan County (TW)

(73) Assignee: PHIHONG TECHNOLOGY CO.,LTD., Taoyuan County (TW)

(21) Appl. No.: 13/672,174

(22) Filed: Nov. 8, 2012

(30) Foreign Application Priority Data
Jul. 25, 2012 (TW) 101214429

(51) Int. Cl. H01F 27/00; H02M 7/04

(52) U.S. Cl. CPC H01F 27/00; H02M 7/043
USPC 363/44; 336/220

(57) ABSTRACT

A non-contact transformer assembly comprises an iron core having a pole with a length longer than the total height of the transmitting coil and the receiving coil to improve the induced voltage and magnetic field of the receiving coil and achieve the high effect of flux conversion.

### FIELD OF THE INVENTION

The invention is relevant to a transformer assembly, especially a non-contact transformer assembly.

### DESCRIPTION OF THE PRIOR ART

Traditional non-contact transformer is used to provide a current and magnetic field. Based on the principle of resonance, the apparatus can receive the inductive electricity and adjust the voltage and current provided to the loading.

The power factor of an electrical power system is defined as the ratio of the real power flowing to the load to the apparent power in the circuit. An electrical power system with the higher power factor can save the energy lost in the distribution. In an electric power system, a load with a low power factor draws more current than a load with a high power factor for the same amount of useful power transferred. The higher currents increase the energy lost in the distribution system, and require larger wires and other equipment. Because of the costs of larger equipment and wasted energy, electrical utilities will usually charge a higher cost to industrial or commercial customers where there is a low power factor.

Electrical resonance occurs in an electric circuit at a particular resonance frequency where the imaginary parts of circuit element impedances or admittances cancel each other. In some circuits this happens when the impedance between the input and output of the circuit is almost zero and the transfer function is close to one. Resonance of a circuit involving capacitors and inductors occurs because the collapsing magnetic field of the inductor generates an electric current in its windings that charges the capacitor, and then the discharging capacitor provides an electric current that builds the magnetic field in the inductor. This process is repeated continually. An analogy is a mechanical pendulum.

The resonance of the circuit system is due to capacitance and inductance in the system. Inductance in the magnetic field is weakened, will produce current, this current will charge the capacitor, but when the capacitor discharge time, discharge current produces a magnetic field, this magnetic field will be to the inductor, the inductance of the magnetic field began to increase. This process is repeated. In some circuits, when the inductor in the circuit reactance and capacitive reactance is the same, also have a resonance, its energy in the magnetic field of the inductor and capacitor voltage swing.

A power transmitter mainly includes the host and the transmitting coil. The receiving coil of the power receiver is inducted to generate the stable voltage and current when the electricity flows through the resonant circuit of the power receiver. Then, the voltage and current are converted to the direct current to be provided to the loading. .

However, there is the requirement to improve the efficiency of the traditional non-contact transformer.

### SUMMARY OF THE INVENTION

The invention aims to solve the above-mentioned problems.

The present invention improves the structure of the non-contact magnetic components with the pole of the iron core whose length is enough to go through both of the transmitting coil and receiving coil. The pole of the iron core improves the magnetic field conversion produced by the two coils to improve the induction voltage of the receiving coil in order to achieve high-flux conversion efficiency.

An aspect of the invention provides a non-contact transformer assembly, comprising: a transmitting iron core connected to a transformer and comprising a pole; an annular transmitting inductor positioned on the transmitting iron core and around the pole for transmitting an electromagnetic energy; a receiving iron core connected to an output circuit, wherein the receiving iron core and the output circuit form an unity to be moved to or away from the transmitting iron core; and an annular receiving inductor positioned on the receiving iron core, wherein when the unity is moved to the transmitting iron core, and the annular receiving inductor engages with the pole and overlaps the annular transmitting inductor, the annular receiving inductor receives the electromagnetic energy transmitted by the annular transmitting inductor, and a length of the pole is enough to go through both of the annular transmitting inductor and the annular receiving inductor.

Another aspect of the invention provides a transformer assembly, wherein the transformer comprises: an electric magnetic interference filter for filtering electric magnetic interference; a bridge rectifier connected to the electric magnetic interference filter; a contact transformer connected to the bridge rectifier, and comprising a primary side inductor and a secondary side inductor for transforming a first current to a second current with high power factor and lowering voltage; a secondary side diode connected to the secondary side inductor in series; a secondary side capacitor connected to an unity of the secondary side inductor and the secondary side diode in parallel; a feedback circuit connected to a high voltage end of the secondary side capacitor; a front stage semiconductor switch connected to the primary side inductor; a controller connected to the feedback circuit and the semiconductor switch and used for controlling the semiconductor switch to turn on or turn off the primary side inductor according to a signal returned by the feedback circuit.

The present invention has the following advantages: (a) the ability to be applied in the products with high power output; (b) the improved magnetic field conversion efficiency of the magnetic component; (c) the elongated contact distance between transmitting and receiving; (d) the primary side and secondary side components of the rear stage half bridge circuit can be switched at zero voltage or zero current to enhance the overall circuit efficiency; (e) when used in a lighting equipment, the requirement for connecting terminals between the lamp and the transformer can be eliminated to save energy and protect environment; (f) the ability to be applied in the wet and moist environments because the requirement for the connecting terminals, which will get rusty, can be eliminated.

### BRIEF DESCRIPTION OF THE DRAWINGS

The primitive objectives and advantages of the present invention will become apparent upon reading the following description and upon reference to the accompanying drawings in which:

FIG. 1 shows the front stage of the transformer according to an embodiment of the invention;

FIG. 2 shows a non-contact transformer assembly according to an embodiment of the invention;

FIG. 3a illustrates the front stage of the non-contact transformer assembly according to another embodiment of the invention;

FIG. 3b illustrates a front stage of the non-contact transformer assembly according to another embodiment of the invention;

FIG. 4a illustrates a rear stage of the non-contact transformer assembly with a half bridge resonant circuit according to an embodiment of the invention;

FIG. 4b shows the rear stage of the non-contact transformer assembly with the half bridge transforming circuit according another embodiment of the invention;

FIG. 4c shows a rear stage of a non-contact transformer assembly with a full bridge transforming circuit according another embodiment of the invention;

FIG. 5a shows a transmitting circuit according to an embodiment of the invention;

FIG. 5b shows a receiving circuit according to an embodiment of the invention; and

FIG. 6 illustrates the engaged condition of the receiving circuit and the transmitting circuit according to an embodiment of the invention.

### DESCRIPTION OF THE PREFERRED EMBODIMENT

Preferred embodiments and aspects of the invention will be described to explain the scope, structures and procedures of the invention. In addition to the preferred embodiments of the specification, the present invention can be widely applied in other embodiments.

The invention provides a non-contact transformer assembly with a high power factor and power factor correction to improve the non-contact transforming efficiency.

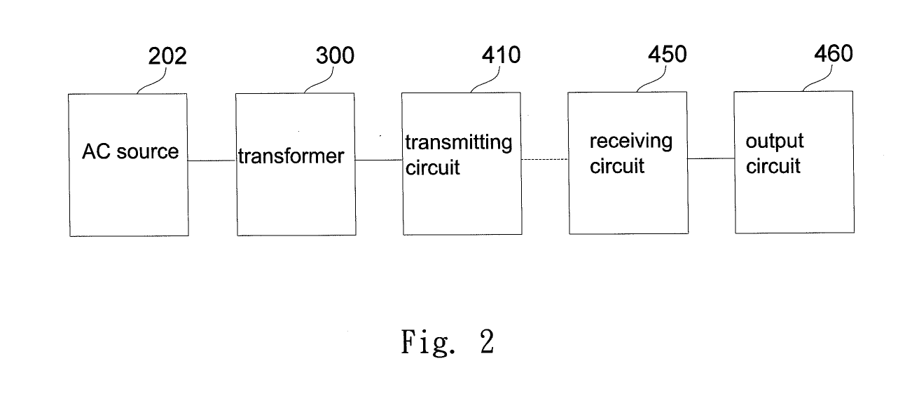

FIG. 2 shows a non-contact transformer assembly according to an embodiment of the invention, including: an alternating current source (202), a transformer (300), a transmitting circuit (410), a receiving circuit (450) [symbol] an output circuit (460). The alternating current source (202) can be supply mains, and the output circuit (460) can be electric loadings, including chargers, lamps, etc. And, the non-contact interface exists between the transmitting circuit (410) and the receiving circuit (450) to replace wires.

When the invention is used in a lighting equipment, the requirement for connecting terminals between the lamp and the transformer can be eliminated to save energy and protect environment.

Meanwhile, the lighting equipment can be applied in the wet and moist environments because the requirement for the connecting terminals, which will get rusty, is eliminated.

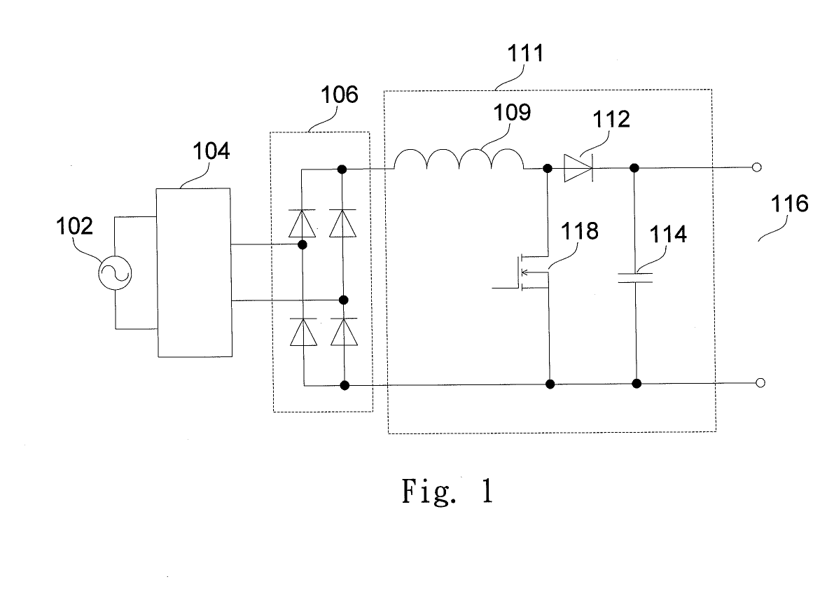

FIG. 1 shows the front stage of the transformer according to an embodiment of the invention, including: an electric magnetic interference filter (104) for filtering electromagnetic interference; a bridge rectifier (106) connected to the electric magnetic interference filter (104). A power factor correction circuit (111) is connected to the bridge rectifier (106), and includes: an inductor (109); a diode (112) connected to the inductor (109) in series; a capacitor (114); and a semiconductor switch (118) connected to the inductor (109).

And, the current with the corrected power factor flows through a front stage output terminal (116) and flows to the input terminal of a rear stage.

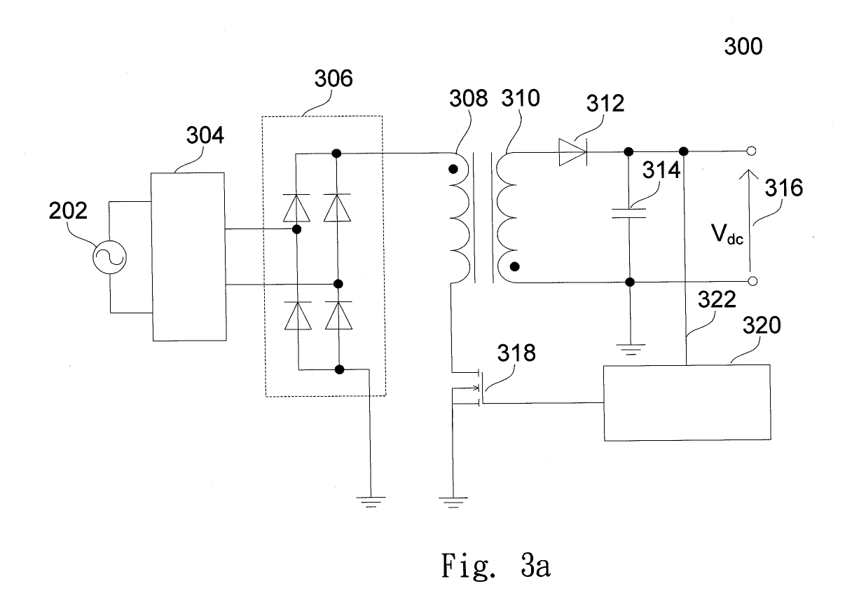

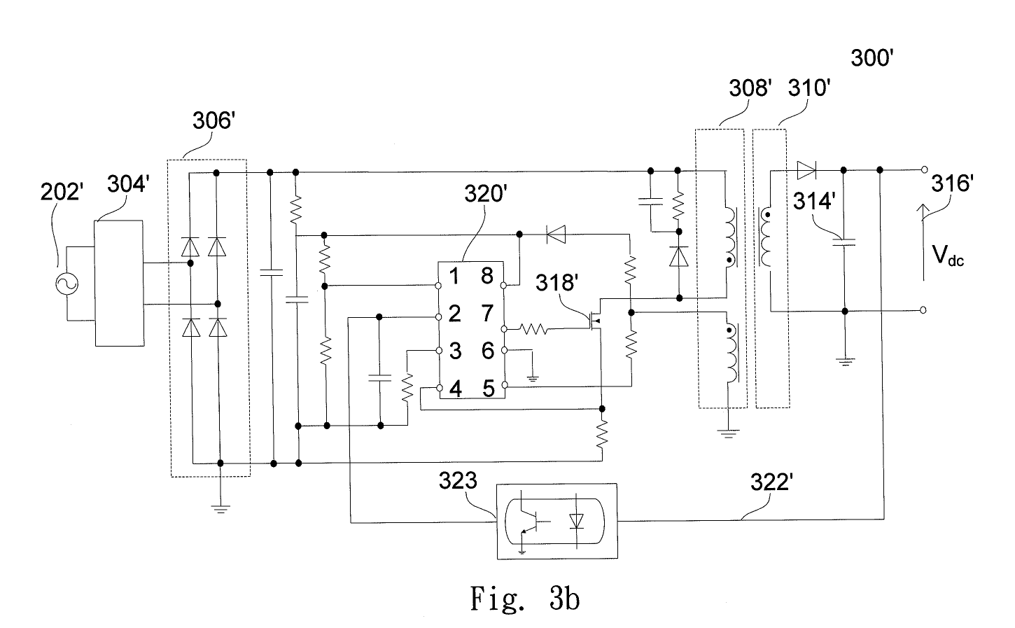

FIG. 3a illustrates the front stage of the non-contact transformer assembly according to another embodiment of the invention. The power factor correction circuit (111) of FIG. 1 is modified and the front stage of the non-contact transformer assembly of the invention is modified to a single stage AC/DC transformer with power factor correction, which increases the power factor and improves the system efficiency. That is, the transformer (300) is a transformer with power factor correction.

By referring to FIG. 3a, the non-contact transformer (300) includes: an electric magnetic interference filter (304) for filtering electromagnetic interference; a bridge rectifier (306) connected to the electric magnetic interference filter (304); a contact transformer connected to the bridge rectifier (306) and including a primary side inductor (308) and a secondary side inductor (310) for transforming a first current (alternating current) to a second current (direct current) with the decreased voltage and high power factor.

Further, the transformer (300) further comprises: a secondary side diode (312) connected to the secondary side inductor (310) in series; a secondary side capacitor (314) connected to the unity of the secondary side inductor (310) and the secondary side diode (312) in parallel; a feedback circuit (322) connected to the secondary side capacitor (314) [symbol] a high voltage end; a front stage semiconductor switch (318) connected to the primary side inductor (308).

A controller (320), which is connected to the feedback circuit (322) and the semiconductor switch (318), controls the semiconductor switch (318) to turn on or turn off the primary side inductor (308) according to a signal returned from the feedback circuit (322).

The current with the power factor correction flows to a front stage output terminal (316).

FIG. 3b illustrates a front stage of the non-contact transformer assembly according to another embodiment of the invention.

By referring to FIG. 3b, a transformer (300′) of a non-contact transformer assembly comprises: an electric magnetic interference filter (304′) for filtering electromagnetic interference; a bridge rectifier (306′) connected to the electric magnetic interference filter (304′); a contact transformer connected to the bridge rectifier (306′) and including a primary side inductor (308′) and a secondary side inductor (310′) for transforming a first current (alternating current) to a second current (direct current) with the decreased voltage and high power factor.

Furthermore, the transformer (300′) further includes: a secondary side diode (312′) connected to the secondary side inductor (310′) in series; a secondary side capacitor (314′) connected to the unity of the secondary side inductor (310′) and the secondary side diode (312′) in parallel; a feedback circuit (322′), of which an end is connected to a high voltage end of the secondary side capacitor (314′), and another end is connected to an optical coupler (323) for transporting a signal; a front stage semiconductor switch (318′) connected to the primary side inductor (308′).

The current with the power factor correction flows to a front stage output terminal (316′).

A controller (320′), which is connected to the feedback circuit (322′) and the semiconductor switch (318′), controls the semiconductor switch (318′) to turn on or turn off the primary side inductor (308′) according to a signal returned from the feedback circuit (322′).

The controller (320′) can be a single-stage flyback and boundary mode power factor correction controller for lighting, including: a FL6961 chip. Elements 1-8 shown in FIG. 3b are the port numbers in the FL6961 chip.

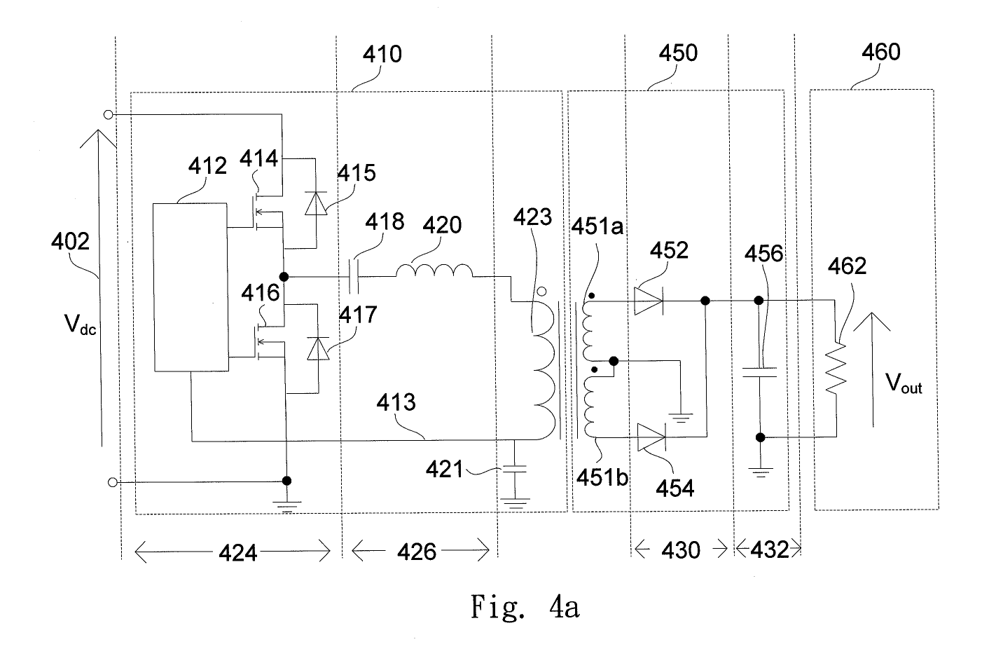

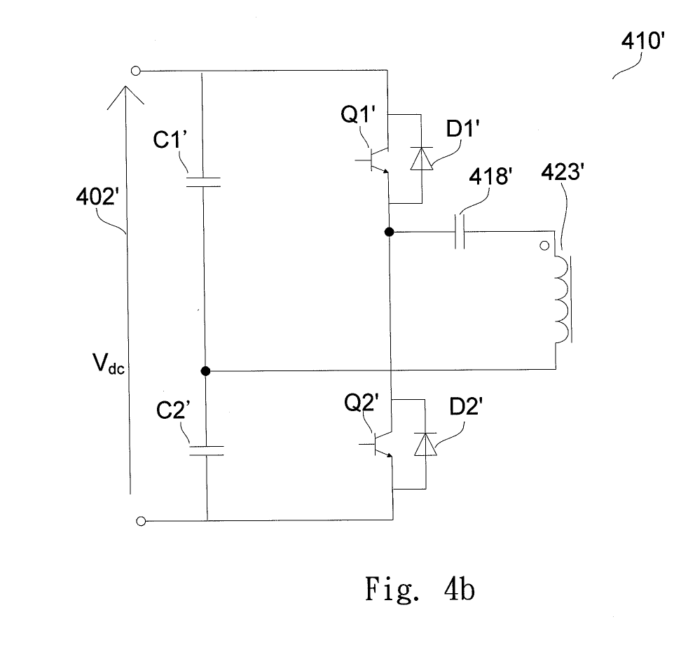

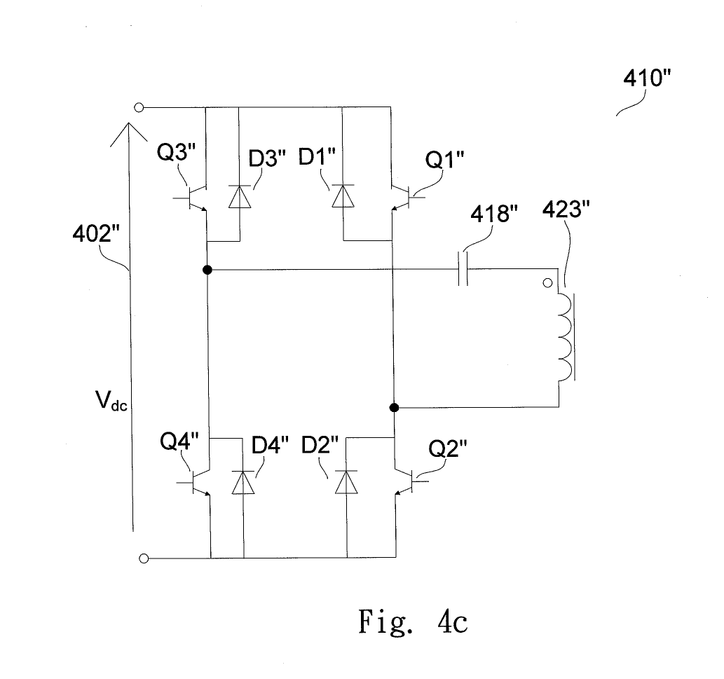

FIG. 4a illustrates a rear stage of the non-contact transformer assembly with a half bridge resonant circuit according to an embodiment of the invention. The primary side transforms the voltage of the direct current output by the front stage to an alternating signal. After the energy transforming through the non-contact magnetic elements, the secondary side transforms the alternating signal to the direct current by the bridge rectifier and provides the direct current to the loading.

The current from the front stage output terminal (element 316 shown in FIG. 3a or element 316′ shown in FIG. 3b) flows to the rear stage input terminal (element 402 shown in FIG. 4a, element 402′ shown in FIG. 4b, element 402″ shown in FIG. 4c).

The rear stage of the non-contact transformer assembly comprises: a transmitting circuit (410) connected to the transformer (element 300 shown in FIG. 3a or element 300′ shown in FIG. 3b), and comprising: a half bridge resonator (412) for transforming the second current (direct current) to a third current (alternating current); and a transmitting inductor (423) for transforming the third current (alternating current) to a electromagnetic energy for wireless transmitting. The half bridge resonator (412) is connected to two rear stage semiconductor switches (414, 416), and two ends of each of the two rear stage semiconductor switches (414, 416) is respectively connected to a diode (415 or 417) to form a controlling switch circuit (424).

The transmitting circuit (410) of the primary side of the non-contact transformer further comprises a feedback circuit (413), of which an end is connected to the point between the transmitting inductor (423) and a ground capacitor (421), and another end is connected to the half bridge resonator (412).

The transmitting circuit (410) further comprises a resonant tank (426) including: a resonant capacitor (418) connected to the controlling switch circuit (424); and a resonant inductor (420) connected to the resonant capacitor (418).

The rear stage of the non-contact transformer assembly further comprises: a receiving circuit (450) including two receiving inductors (451a, 451b) for receiving the electromagnetic energy by the electromagnetic induction and transforming to a fourth current (direct current). An output circuit (460) is connected to the receiving circuit (450) for outputting the fourth current (direct current). The two receiving inductors (451a, 451b) are connected to two rectifying diodes (452, 454) to form a bridge rectifier circuit (430).

The bridge rectifier circuit (430) is connected to a low pass filtering circuit (432) including a low pass filtering capacitor (456). The controlling switch circuit (424) is controlled by resonance and frequency-modulation to be switched at zero current.

Thus, the rear stage is a non-contact driving circuit and a half bridge resonant circuit with frequency-modulation, which switches the elements in the primary side at zero voltage by the resonant theory. When the loading in the secondary side varies, the resonant curve in the primary side varies, and the operative frequency also varies. Thus, the operative frequency is optimum in any loading and resonant curve. The primary side switch can be switched at zero voltage and the secondary side rectifying element can be switched at zero current. Therefore, the loss of switching in the whole circuit can be reduced to improve the efficiency of the whole circuit.

FIG. 4b shows the rear stage of the non-contact transformer assembly with the half bridge transforming circuit according another embodiment of the invention. A transmitting circuit (410′) is used to replace the transmitting circuit (410) shown in FIG. 4a to connect the transformer (300 or 300′) shown in FIG. 3a or 3b. The transmitting circuit (410′) comprises: a half bridge transforming circuit to transform the second current (direct current) to a third current (alternative current); and a transmitting inductor (423′) to transform the third current (alternative current) to a electromagnetic energy to be transmitted wirelessly. The half bridge transforming circuit comprises: two rear stage capacitors (C1′, C2′); and two rear stage semiconductor switches (Q1′, Q2′), each of which has two ends connected to a diode (D1′, D2′) to form a controlling switch circuit.

FIG. 4c shows a rear stage of a non-contact transformer assembly with a full bridge transforming circuit according another embodiment of the invention. A transmitting circuit (410″) is used to replace the transmitting circuit (410) shown in FIG. 4a to connect the transformer (300 or 300′) shown in FIG. 3a or 3b. The transmitting circuit (410″) comprises: a full bridge transforming circuit to transform the second current (direct current) to a third current (alternative current); and a transmitting inductor (423″) to transform the third current (alternative current) to an electromagnetic energy to be transmitted wirelessly. The full bridge transforming circuit comprises: four rear stage semiconductor switches (Q1′, Q2′, Q3′, Q4′), each of which has two ends connected to a diode (D1′, D2′, D3′, D4′) to form a controlling switch circuit.

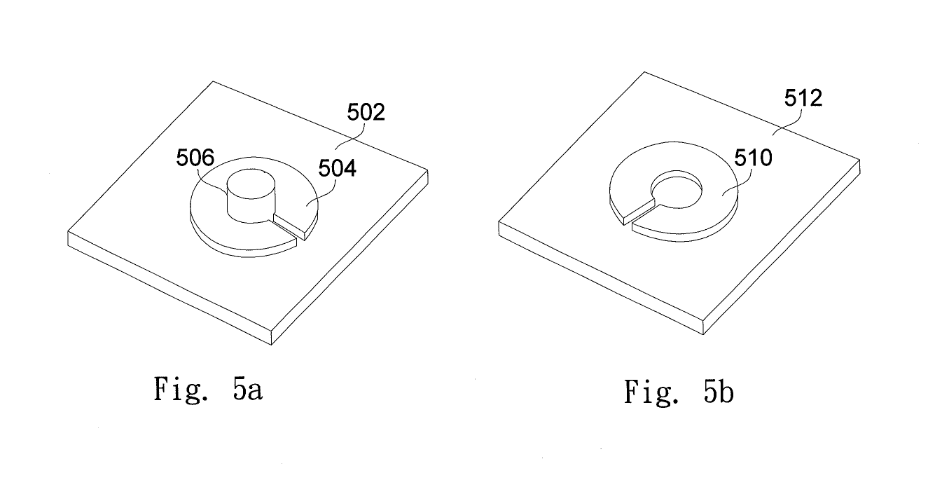

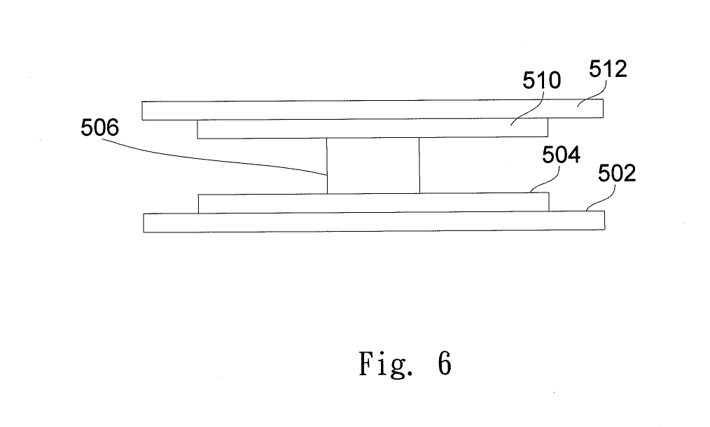

FIG. 5a shows a transmitting circuit according to an embodiment of the invention, and FIG. 5b shows a receiving circuit according to an embodiment of the invention. FIG. 6 illustrates the engaged condition of the receiving circuit and the transmitting circuit according to an embodiment of the invention.

By referring to FIG. 5a, the transmit iron core (502) functions as the transmitting circuit (410) of FIGS. 2 and 4a. The transmitting inductor is an annular transmitting inductor (504), and the transmit iron core (502) comprises a pole (506) located in the center of the annular transmitting inductor (504).

By referring FIG. 5b, the receiving iron core (512) functions as the receiving circuit (450) of FIGS. 2 and 4a, and has a receiving inductor, i.e., an annular receiving inductor (510). When the annular receiving inductor (510) engages with the pole (506) and overlaps the annular transmitting inductor (504), the annular receiving inductor (510) receives the electromagnetic energy transmitted by the annular transmitting inductor (504).

The shapes of the pole (506) and the base part of the iron core can be: cylinder, cone, cuboid, or pyramid. The length of the pole (506) is enough to go through both coils of the annular receiving inductor (510) and annular transmitting inductor (504). The two coils perform the magnetic field conversion around the pole (506) of the transmit iron core (502), and the induction voltage of the receiving coil, i.e., the annular receiving inductor (510), can be increased to achieve high-flux conversion efficiency

The receiving core (512) can be connected to an output circuit, which can be a loading including a charger, a lamp, and etc.

The above-described embodiments of the present invention are intended to be illustrative only. Numerous alternative embodiments may be devised by those skilled in the art without departing from the scope of the following claims.

What is claimed is:

1. A non-contact transformer assembly, comprising:
a transmitting iron core connected to a transformer and comprising a pole;
an annular transmitting inductor positioned on the transmitting iron core and around the pole for transmitting an electromagnetic energy;
a receiving iron core connected to an output circuit, wherein the receiving iron core and the output circuit form an unity to be moved to or away from the transmitting iron core; and
an annular receiving inductor positioned on the receiving iron core,
wherein when the unity is moved to the transmitting iron core, and the annular receiving inductor engages with the pole and overlaps the annular transmitting inductor, the annular receiving inductor receives the electromagnetic energy transmitted by the annular transmitting inductor, and a length of the pole is enough to go through both of the annular transmitting inductor and the annular receiving inductor.

2. The transformer assembly of claim 1, wherein the transformer comprises:
an electric magnetic interference filter for filtering electric magnetic interference;
a bridge rectifier connected to the electric magnetic interference filter;
a contact transformer connected to the bridge rectifier, and comprising a primary side inductor and a secondary side inductor for transforming a first current to a second current with high power factor and lowering voltage;
a secondary side diode connected to the secondary side inductor in series;
a secondary side capacitor connected to an unity of the secondary side inductor and the secondary side diode in parallel;
a feedback circuit connected to a high voltage end of the secondary side capacitor;
a front stage semiconductor switch connected to the primary side inductor;
a controller connected to the feedback circuit and the semiconductor switch and used for controlling the semiconductor switch to turn on or turn off the primary side inductor according to a signal returned by the feedback circuit.

3. The transformer assembly of claim 2, wherein:
the first current is an alternating current; and
the second current is a direct current.

4. The transformer assembly of claim 2, wherein the transformer is a power factor correcting transformer.

5. The transformer assembly of claim 2, wherein the controller is a single stage flyback and boundary mode power factor correcting controller.

6. The transformer assembly of claim 1, wherein the transmitting iron core further comprises a half bridge resonator.

7. The transformer assembly of claim 6, wherein the half bridge resonator is connected to two rear stage semiconductor switches to form a controlling switch circuit.

8. The transformer assembly of claim 7, further comprising a resonant tank including: a resonant capacitor connected to the controlling switch circuit; and a resonant inductor connected to the resonant capacitor.

9. The transformer assembly of claim 7, wherein the annular receiving inductor is connected to two rectifying diodes to form a bridge rectifier circuit and the controlling switch circuit is controlled by resonance and frequency-modulation to be switched at zero current.

10. The transformer assembly of claim 1, wherein shapes of the pole is: cylinder, cone, cuboid, or pyramid.
